(19) United States
(12) Patent Application Publication
(10) Pub. No.: US 2024/0237640 A1
(43) Pub. Date: Jul. 18, 2024

(54) STABLE AGROCHEMICAL SUSPENSION CONCENTRATE COMPOSITIONS

(71) Applicant: ADAMA AGAN LTD., Ashdod (IL)

(72) Inventors: David MOCATTA, Gedera (IL); Vladimir GUBRIY, Ashdod (IL); Victoria BABUSHKIN, Ashdod (IL); Gilad SILBERT, Kibbutz Dorot (IL)

(73) Assignee: ADAMA AGAN LTD., Ashdod (IL)

(21) Appl. No.: 18/560,244

(22) PCT Filed: May 10, 2022
(86) PCT No.: PCT/IL2022/050483

§ 371 Date: Nov. 10, 2023

Related U.S. Application Data
(60) Provisional application No. 63/186,219, filed on May 10, 2021.

(51) Int. Cl. A01N 25/30; A01N 25/04; A01N 37/22; A01P 13/00

(52) U.S. Cl. CPC A01N 25/30; A01N 25/04; A01N 37/22; A01P 13/00

(57) ABSTRACT

The present invention is directed to an aqueous suspension concentrate composition comprising an anilide herbicide and a dispersant combination comprising a) a graft or comb copolymer containing polyalkylene oxide moieties grafted on a polymeric backbone; b) an anionic dispersant having an SO3 group; and c) a poly alkoxy late of mono-, di- or tristyrylphenol. The invention is further directed to a suspension concentrate composition comprising an anilide herbicide and an antifreeze combination of urea and propane-1,2-diol. Disclosed are methods to prepare the compositions and their use for the control of undesired plants.

### FIELD OF THE INVENTION

The present invention relates to an agrochemical composition. Specifically, it relates to stable concentrated suspensions of anilide herbicides. The invention is further directed to a process for preparing the suspensions and their use in crop protection.

### BACKGROUND

Crop protection compositions can be formulated in different ways. Generally, there is a need for highly concentrated formulations that may be diluted by the end user before applying in the field.

Suspension Concentrate (SC) formulations are defined as suspensions of solid particulate active ingredient in a liquid media which is intended for dilution before use. The liquid media can be water, or a mixture of water with any organic/inorganic solvents, in which the active ingredient is insoluble or sparingly soluble. SCs have the advantage over powder formulations that they do not produce dust upon reconstitution. Aqueous suspension concentrates have the benefit of not requiring the use of organic solvents, providing good safety and user convenience.

However, the preparation of a stable suspension concentrate formulation is a challenging task. A major drawback of formulating a sparingly water-soluble active ingredient, such as propanil, as an aqueous SC is Ostwald ripening, wherein the larger crystals of the ingredient grow while the smaller crystals dissolve. This leads to unacceptable PhysChem properties, such as high viscosity, resulting in poor pourability. Large crystals may settle out of suspension, which can lead to the separation of the liquid and solid phases above the acceptable industry standard and result in caking of the solid at the bottom of the vessel.

SC formulations may also show increased crystal growth after freeze thaw cycles. The freeze thaw process perturbs the equilibrium between the solid, dispersant and dissolved active ingredient molecules, resulting in increased crystal growth. Dispersants are normally added to SC formulations as they bind to the surface of solids and aid in their suspension in the liquid phase. In addition, the surface coverage that they provide aids in the retardation of crystal growth.

US2015/0099637 describes suspension concentrate compositions comprising at least one anilide herbicide compound as the active ingredient and containing at least one carbamate compound as a crystallization suppressant. U.S. Pat. No. 8,618,022 relates to a process for preparing an aqueous suspension of an organic pesticide compound.

It is an object of the present invention to provide a stable aqueous suspension concentrate composition, having a low viscosity and minimal crystal growth even in high loads of active ingredient.

### SUMMARY OF THE INVENTION

The present invention provides a stable agrochemical aqueous suspension concentrate composition comprising, as an active ingredient, an anilide herbicide.

In a first aspect, the invention provides an aqueous suspension concentrate composition comprising an anilide herbicide and a dispersant combination, wherein the dispersant combination comprises: a) a graft or comb copolymer comprising polyalkylene oxide moieties grafted on a polymeric backbone; b) an anionic dispersant having an SO3 group; and c) a polyalkoxylate of mono-, di- or tristyrylphenol. It has surprisingly been found that including said dispersant combination in aqueous suspension concentrate compositions of anilide herbicides results in reduced crystal growth during and after the manufacturing process.

In another aspect, the invention provides an aqueous suspension concentrate composition comprising an anilide herbicide and a combination of urea and propylene glycol. Use of said combination as antifreeze agents in aqueous suspension concentrate compositions of anilide herbicides was found to impart PhysChem stability to the compositions, specifically after freeze-thaw cycles, and results in retardation of crystal growth.

In another aspect, the invention provides an aqueous suspension concentrate composition comprising an anilide herbicide and a dispersant combination, wherein the dispersant combination comprises: a) a graft or comb copolymer comprising polyalkylene oxide moieties grafted on a polymeric backbone; and b) a polyoxyethylene-polyoxypropylene block copolymer or an alkyl ether thereof.

A further aspect of the invention is directed to the process for preparing the suspension of the invention.

The invention further provides the use of the compositions of the invention for the control of undesired plants. Further provided is a method for the control of undesired plants comprising contacting an effective amount of the compositions of the invention with the locus of said undesired plants.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

By the term “aqueous” as used herein, is meant that the diluent used in the composition is mainly water. Hence, “aqueous” and “water-based” may be considered synonyms. Particle size is typically defined as a log-normal distribution with a median diameter or d50. The term “d50” defines a size where 50 volume percent of the particles have sizes less than the value given. The term “d90” defines a size where 90 volume percent of the particles have sizes less than the value given. The particle size distributions can be measured using laser light diffraction equipment, such as Malvern Mastersize 2000 instrument.

As used herein, the term “stable” when used in connection with physical stabilization or when used in connection with a composition means that no significant crystallization, sedimentation and/or thickening was observed, and always within acceptable limits for the normal use intended for the formulation.

As used herein, the term “effective amount” when used in connection with an active ingredient or a formulation containing it refers to an amount of the active ingredient that, when ingested, contacted with or sensed, is sufficient to achieve a good level of control or activity of a pest, disease and/or unwanted plant.

An “active ingredient” is a substance capable of controlling unwanted plants (weeds), plant pests or plant diseases, and does not cause significant damage to the treated crop plants. The term “active ingredient” comprises, but is not limited to insecticides, nematicides, herbicides, fungicides, algicides, animal repellents or acaricides. Active ingredients are not limited to pesticides and also include for example hormones, bio-stimulants, and plant growth regulators.

As used herein the term “plant” or “crop” or “crop plants” includes reference to whole plants, plant organs (e.g. leaves, stems, twigs, roots, trunks, limbs, shoots, fruits etc.), plant cells, or plant seeds, which have industrial interest, including grasslands and pastures, such as for example plants destined to human consumption, animal consumption or other industrial uses. This term also encompasses crops such as fruits. The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts basal shoots, stolons, and buds and other parts of plants, including seedlings and young plants, which are to be transplanted after germination or after emergence from soil. As used herein, the term “crop” includes plants which have been modified by breeding, mutagenesis or genetic engineering. Genetically modified plants are plants in which their genetic material has been modified by the use of recombinant DNA techniques. Typically, one or more genes have been integrated into the genetic material of such a plant in order to improve certain properties of the plant.

As used herein, the term “locus” includes a habitat, breeding ground, plant, propagation material, soil, area, material or environment in which an undesired plants, pest or disease is growing or may grow.

As used herein, the terms “control” or “controlling” or “combatting” refers to preventing disease, pests or the growth of unwanted plants, protecting plants from diseases or pests, delaying the onset of disease, and killing, or to reducing the deleterious effects of the disease, or pests, or to killing or to reducing growth of unwanted plants.

The term “a” or “an” as used herein includes the singular and the plural, unless specifically stated otherwise. Therefore, the terms “a,” “an” or “at least one” can be used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

The term “propylene glycol” as used herein means propane-1,2-diol. The terms “propylene glycol” and “propane-1,2-diol” are used herein interchangeably.

### The Compositions of the Invention

The invention provides an aqueous suspension concentrate (SC) composition comprising an anilide herbicide.

Suitable anilide herbicides that may be used in the composition of the invention may be selected, as an example, from the group consisting of chloranocryl, cisanilide, clomeprop, cypromid, diflufenican, erlujixiancaoan, etobenzanid, fenasulam, flufenacet, flufenican, ipfencarbazone, mefenacet, mefluidide, metamifop, monalide, naproanilide, pentanochlor, picolinafen, propanil, sulfentrazone and tetflupyrolimet; or from the group of arylalanine herbicides consisting of: benzoylprop, flamprop and flamprop-M; or from the group of chloroacetanilide herbicides consisting of: acetochlor, alachlor, amidochlor, butachlor, butenachlor, delachlor, diethatyl, dimethachlor, ethachlor, ethaprochlor, metazachlor, metolachlor, S-metolachlor, pretilachlor, propachlor, propisochlor, prynachlor, terbuchlor, thenylchlor and xylachlor; or from the group of sulfonanilide herbicides consisting of: benzofluor, cloransulam, diclosulam, dimesulfazet, florasulam, flumetsulam, metosulam, perfluidone, profluazol, pyrimisulfan and triafamone.

In a preferred embodiment, propanil is the anilide herbicide. Propanil [N-(3,4-dichlorophenyl)propenamide] is a PS-II contact herbicide corresponding to the following formula:

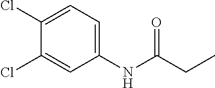

Typically, the compositions of the invention comprise from about 10% to 90% by weight of anilide herbicide, preferably from about 20% to 80% by weight, and more preferably from about 40% to 60% by weight.

In addition to the anilide herbicide, the suspension concentrate compositions of the invention may comprise agriculturally acceptable inert additives (also known as “co-formulants”). These are defined herein as any substance that itself is not an active ingredient but is added to the composition to improve its properties. Non-limiting examples of agriculturally acceptable inert additives include surfactants, dispersants, wetting agents, antifreeze agents, thickening agents, suspending agents, antifoaming agents, preservatives, antioxidation agents, binders, buffers, humectants, plant penetrants (or translocators), fertilizers, drift retardants, inverting agents, soil penetrants and UV absorbers.

Preferably, the compositions of the invention comprise a surfactant. The term surfactant, which includes the terms dispersant and wetting agent, as used herein, means a composition of matter that either alters surface tension when dissolved in water or an aqueous solution or alters interfacial tension between immiscible liquids or a liquid and a solid. Suitable surfactants include, but are not limited to, acrylate graft copolymer ethoxylates, cresol- or naphthalene-formaldehyde condensates and their sulfonates, tristyrylphenol ethoxylates, alkylamine ethoxylates, block polymers, such as ethylene oxide/propylene oxide condensates or ethers thereof; carboxylated alcohol or alkylphenol ethoxylates, alcohol ethoxylates, ethoxylated alkylphenols, glycol esters, polyethylene glycols, silicone-based surfactants, lignosulfonates; polycarboxylates and derivatives thereof.

Particularly preferred are the dispersant combination comprising a) a graft or comb copolymer comprising polyalkylene oxide moieties grafted on a polymeric backbone; b) an anionic dispersant having an SO3 group; and c) a polyalkoxylate of mono-, di- or tristyrylphenol; or the dispersant combination comprising a) a graft or comb copolymer comprising polyalkylene oxide moieties grafted on a polymeric backbone; and b) a polyoxyethylene-polyoxypropylene block copolymer or an alkyl ether thereof. It has surprisingly been found that including said dispersant combinations in aqueous suspension concentrate compositions of anilide herbicides results in reduced crystal growth during and after the manufacturing process. Such reduction in the crystal growth is translated in more stable particle sizes over time and/or in less variations in the viscosity of the formulation.

Thus, in one embodiment, the invention provides an aqueous suspension concentrate (SC) composition comprising an anilide herbicide and a dispersant combination comprising: a) a graft or comb copolymer comprising polyalkylene oxide moieties grafted on a polymeric backbone; b) an anionic dispersant having an SO3 group; and c) a polyalkoxylate of mono-, di- or tristyrylphenol.

In other embodiment, the invention provides an aqueous suspension concentrate (SC) composition comprising an anilide herbicide and a dispersant combination comprising: a) a graft or comb copolymer comprising polyalkylene oxide moieties grafted on a polymeric backbone; and b) a polyoxyethylene-polyoxypropylene block copolymer or an alkyl ether thereof.

The graft or comb copolymers comprise polyalkylene oxide moieties grafted on a polymeric backbone. Preferably, the polyalkylene oxides are poly-C2-C4-alkylene oxides or ethers thereof, such as mono-C1-C4-alkylethers thereof. Preferably, carboxylate groups are attached to the polymer backbone.

Preferred graft or comb copolymers may contain, in polymerised form: (i) at least one C3-C5 monoethylenically unsaturated carboxylic acid monomer, such as acrylic acid or methacrylic acid; (ii) at least one monomer having a poly-C2-C4-alkylene oxide group, which is attached either by ester or ether linkages to a polymerizable monoethylenically unsaturated double bond; in particular, an ester of a polyethylenoxide or of a polyethylenoxide mono-C1-C4-alkylether with a C3-C5 monoethylenically unsaturated carboxylic acid monomer, such as acrylic or methacrylic acid; and (iii) optionally hydrophobic monomers such as C1-C10-alkylesters of C3-C5 monoethylenically unsaturated carboxylic acid monomers, in particular C1-C10-alkylesters of acrylic acid or methacrylic acid, e.g. methylacrylate, methylmethacrylate, ethylacrylate, ethylmethacrylate, propylacrylate, propylmethacrylate, butylacrylate and butylmethacrylate; or vinylaromatic monomers such as styrene, or aryl substituted C3-C5 monoethylenically unsaturated carboxylic acid monomers, e.g. 2-phenylacrylic acid or an ester thereof.

In a preferred embodiment, the graft or comb polymer contains or consists of, in polymerized form, methacrylic acid, methyl methacrylate and an ester of polyethylene oxide or a C1-C4 alkylether thereof (e.g. monomethylether thereof) with methacrylic acid. Such polymer is commercially available, for example, as Atlox 4913 (Croda).

The anionic dispersant having an SO3 group is preferably a polymeric dispersant, such as a condensate of aryl sulfonic acid, e.g. naphthalenesulfonic acid or phenolsulfonic acid, with formaldehyde and optionally with urea. The aryl sulfonic acid may be e.g. phenol sulfonic acid or naphthalene sulfonic acid which is unsubstituted or substituted by one or more substituents such as alkyl groups. Preferably, the anionic dispersant having an SO3 group is an alkaline or earth alkaline metal salt of a condensate of naphthalene sulfonic acid and formaldehyde; Such polymer is commercially available, for example, as Morwet D-425 (Nouryon).

In the styrylphenol polyalkoxylate dispersants, a phenoxy radical carries 1, 2 or 3 styryl moieties and a polyalkylene oxide moiety, which is typically a polyethylene oxide (PEO), polypropylene oxide (PPO), or a poly(ethylenoxide-propylenoxide) (PEO/PPO) moiety. The polyalkylene oxide moiety typically comprises from about 5 to 100 alkylene oxide groups. Preferred surfactants of this group are ethoxylated tri(styryl)phenols group; commercially available, for example, as Soprophor TS54 (Solvay).

In a preferred embodiment, the polyoxyethylene-polyoxypropylene block copolymer or an alkyl ether thereof is an alkyl ether, and preferably, it is a C1-C10 alkyl ether. Particularly preferred is polyoxyethylene-polyoxypropylene block copolymer butyl ether, commercially available, for example, as Atlas G5000 (Croda).

In a preferred embodiment, the aqueous suspension concentrate (SC) composition comprising an anilide herbicide and a dispersant combination comprising: a) a graft or comb copolymer comprising polyalkylene oxide moieties grafted on a polymeric backbone; b) an anionic dispersant having an SO3 group; and c) a polyalkoxylate of mono-, di- or tristyrylphenol, in addition to the dispersant combination, also comprises a polyoxyethylene-polyoxypropylene block copolymer or an alkyl ether thereof, such as C1-C10 alkyl ethers thereof. Preferably, the block copolymer is nonionic. Particularly preferred is polyoxyethylene-polyoxypropylene block copolymer butyl ether, commercially available, for example, as Atlas G5000 (Croda).

In another preferred embodiment, the aqueous suspension concentrate (SC) composition comprising an anilide herbicide and a dispersant combination comprising: a) a graft or comb copolymer comprising polyalkylene oxide moieties grafted on a polymeric backbone; and b) a polyoxyethylene-polyoxypropylene block copolymer or an alkyl ether thereof, also comprises an anionic dispersant having an SO3 group, or a polyalkoxylate of mono-, di- or tristyrylphenol.

Each of the dispersants is preferably present in the compositions of the invention in an amount of from about 0.01% to about 20% by weight of the composition, more preferably from about 0.01% to about 10% by weight, and even more preferably from about 0.05% to about 5.0% by weight, the most preferably from about 0.2% to about 4.0% by weight.

Antifreezing agents that may be employed in the compositions of the invention include, for example, mono- and polyols (the term “polyols” as used herein refers to organic compounds comprising more than one hydroxyl group), such as C1-C4 alkanols and C2-C4 polyols. Examples of suitable C1-C4 alkanols include methanol, ethanol and isopropanol. Examples of suitable C2-C4 polyols include ethylene glycol, propane-1,2-diol, propane1,3-diol and glycerol. Other suitable polyols include polyhydroxylated sugars such as glucose. Polyalkyleneglycols (such as polyethylene glycol and polypropylene glycol) and glycol ethers (such as dipropylene glycol) may also be used as antifreezing agents. Other suitable antifreezing agents include urea or salts such NaCl, CaCl2 and Na2SO4.

Preferably, a combination of urea and an alkylene glycol is used as the antifreezing agent, and more specifically, urea and propylene glycol (propane-1,2-diol). While use of either propylene glycol or urea as the sole antifreeze agent in anilide herbicide suspension concentrate formulations gave unsatisfactory results in terms of viscosity and crystal growth, use of their combination was found to impart PhysChem stability to the compositions, and showed minimal increase in viscosity and particle size, specifically following freeze-thaw cycles. Unexpectedly it was found that increase in the weight ratio of propylene glycol:urea above about 1:1 results in lower viscosity and crystal growth.

Thus, in another aspect, the invention provides an aqueous suspension concentrate composition comprising an anilide herbicide, urea and propylene glycol.

A propylene glycol:urea weight ratio of above 1:1 to about 50:1 is preferred, and more specifically, a ratio chosen from above 1.0:1, above 1.05:1, above 1.1:1, above 1.2:1, above 1.21:1, or above 1.22:1 or above 1.4:1; up to a ratio of about 50:1, preferably about 20:1, 10:1, 5:1 or 2:1. The antifreeze combination, comprising urea and propylene glycol, is preferably present in an amount of from about 0.1% to about 20% by weight of the compositions of the invention, more preferably from about 3.0% to about 15% by weight and even more preferably from about 6% to about 15%. The urea is present in an amount of from about 0.1% to about 20% by weight of the compositions of the invention, preferably from about 1.0% to about 10% by weight, more preferably from about 2.0% to about 8.0% by weight and even more preferably from about 2.5% to about 4%.

In a preferred embodiment, the invention provides an aqueous suspension concentrate (SC) composition which comprises an anilide herbicide and a dispersant combination comprising: a) a graft or comb copolymer comprising polyalkylene oxide moieties grafted on a polymeric backbone; and b) a polyoxyethylene-polyoxypropylene block copolymer or an alkyl ether thereof; urea and propylene glycol. More preferably the propylene glycol:urea weight ratio is of above 1:1 to about 50:1, and more specifically, a ratio chosen from above 1.0:1, above 1.05:1, above 1.1:1, above 1.2:1, above 1.21:1, or above 1.22:1 or above 1.4:1; up to a ratio of about 50:1, preferably about 20:1, 10:1, 5:1 or 2:1. Even more preferably, the propylene glycol:urea weight ratio is of above 1:1 to about 50:1, and more specifically, a ratio chosen from above 1.0:1, above 1.05:1, above 1.1:1, above 1.2:1, above 1.21:1, or above 1.22:1 or above 1.4:1; up to a ratio of about 50:1, preferably about 20:1, 10:1, 5:1 or 2:1 and the sum of urea and propylene glycol is in an amount of from about from about 0.1% to about 20% by weight of the compositions, more preferably from about 3.0% to about 15% by weight and even more preferably from about 6% to about 15% by weight of the composition.

Examples of suitable suspending agents and/or thickeners that may be employed in the compositions of the invention include polysaccharides such as alginates, acacia gum, tragacanth, guar gum, bean gum, gum Arabic, carrageenan, xanthan gum, cellulose, methylcellulose (MC), sodium carboxymethylcellulose (CMC), hydroxypropylmethylcellulose (HPMC), hydroxyethylcellulose, carboxymethylcellulose; carbomers; or surface-modified silica. The suspending agents and/or thickeners are typically present in an amount of from about 0.001% to about 2% by weight of the composition.

Examples of antifoaming agents that may be employed in the compositions of the invention include siliconic antifoaming agents such as polydimethylsiloxanes, alkylcyclotetrasiloxane and other silicones. Typically, such siliconic antifoaming agents are commercially available as aqueous emulsions. The antifoaming agent is typically present in an amount of from about 0.001% to about 2% by weight of the composition.

Preservatives such as isothiazolones may be used to prevent microbial spoiling of the composition.

Water is used as the continuous phase in the suspension compositions of the invention. It is present in an amount that would dilute the active ingredient to a desired concentration, typically between about 20% to about 80% by weight of the composition, preferably between about 25% to about 65%, more preferably from about 30% to about 55%, even more preferably from about 35% to about 50%, the most preferably from about 40% to about 45%.

Preferably, the suspension concentrate compositions of the invention have a pH of above 7, and more specifically, between about 7 and 14; more preferably between about 8 and 11, and even more preferably between about 8.5 and 10.5. It has been found that at a basic pH, the compositions are advantageous in terms of viscosity and crystal growth. The pH of the composition may be modified by the addition of a base such as, for example, sodium hydroxide.

The suspension concentrate composition of the invention showed superior stability after 8 weeks in 40° C., in terms of viscosity and particle size. In a preferred embodiment, following 8 weeks in 40° C., the suspension concentrate composition of the invention has a D(90) particle size (when measured on a Malvern Mastersizer 2000, as described hereinbelow) of less than 30 μm, preferably less than 27 μm, less than 25 μm, or even less than 20 μm. In a preferred embodiment, following 8 weeks in 40° C., the suspension concentrate composition of the invention has a viscosity (when measured using a Brookfield LV viscometer, as described hereinbelow) of less than 2500 cP, preferably less than 2000 cP, less than 1800, 1600, 1400, 1200, 1100 or even less than 1000 cP.

Viscosity can be measured using a Brookfield LV viscometer instrument at 12 rpm at a temperature of 25.0° C. using spindle 62 (for viscosities above 2000 cP, spindle 63 is used).

Particle size can be measured using a Malvern Mastersizer 2000 instrument equipped with a small sample dispersion unit. Measurement parameters are chosen so that the residual and weighted residual values of the measurements are between 0.8-1.3, for example the refractive index of the sample is set at 1.632 and its absorption at 0.01 for both red and blue light measurements. The background sample time is 20 seconds and the number of background measurement images is 20,000. The sample time is 10 seconds and the number of sample measurement images is 10,000. Both the background and the sample measurements are taken with debubbled water. Drops of the formulation are added to water at room temperature (20-27° C. at atmospheric pressure) in the unit at a stirring speed of 800 rpm, until the obscuration is between 15-25% and stable (+/−5% of the obscuration value) for a period of at least 2 minutes. Then the measurement is taken.

In a specific embodiment, the present invention provides a propanil suspension concentrate composition wherein, following 8 weeks in 40° C., the composition has a) a D(90) particle size (when measured on a Malvern Mastersizer 2000) of less than 30 μm, preferably less than 27 μm, less than 25 μm, or even less than 20 μm; or b) a viscosity (when measured using a Brookfield LV viscometer) of less than 2500 cP, preferably less than 2000 cP, less than 1800, 1600, 1400, 1200, 1100 or even less than 1000 cP.

The suspension concentrate compositions of the invention can be diluted with water or mixed with tank adjuvant solutions prior to their application in the field to improve physical properties and efficacy. Some substances, such as plant penetrants (or translocators), fertilizers, drift retardants or soil penetrants, can be used as agriculturally acceptable inert additives in the compositions of the invention or mixed as tank additives with the composition of the invention prior to application in the field. The tank mixes resulting from diluting the compositions of the invention with water or mixing the compositions with one or more tank adjuvant solutions are also an aspect of the present invention.

### Method of Preparation of the Suspension Concentrate Compositions

A further aspect of the invention is directed to the process for preparing the suspension of the invention. The process comprises the following steps: a) adding the co-formulants except for the active ingredient and the suspending agents and/or thickeners (if present) to the water and stirring until fully dispersed/dissolved; b) adding the active ingredient and homogenizing; c) milling to the desired particle size; d) optionally, adding the suspending agents and/or thickeners; and e) optionally, modifying the pH by the addition of a base or acid.

Homogenization is typically carried out using a high shear homogenizer such as Ultra turrax. Milling may be carried out with zirconium beads. For example, a WAB lab research instrument may be used.

### Methods and Applications

The present document discloses a method for controlling undesired plants comprising contacting an effective amount of the suspension concentrate compositions of the invention, or their diluted tank mixes, with the locus of said undesired plants.

The methods disclosed in the present document refer to any undesired plant for which the herbicide has known activity. In the same way the methods disclosed in the present document refer to any crop for which the herbicide has known protecting activity. The methods disclosed in the present document refer to any crop plants, including but not limited to monocotyledons such as sugar cane, cereals, rice, maize (corn); or dicotyledon crop such as beets (such as sugar beet or fodder beet); fruits (such as pomes, stone fruits, or soft fruits, for example apples, pears, plums, peaches, almonds, cherries, strawberries, raspberries, or blackberries); leguminous plants (such as beans, lentils, peas, or soybeans); oil plants (such as rape, mustard, poppy, olives, sunflowers, coconut, castor oil plants, cocoa beans, or groundnuts); cucumber plants (such as marrows, cucumbers or melons); fiber plants (such as cotton, flax, hemp, or jute); citrus fruits (such as oranges, lemons, grapefruit, or mandarins); vegetables (such as spinach, lettuce, cabbages, carrots, tomatoes, potatoes, cucurbits, or paprika); lauraceae (such as avocados, cinnamon, or camphor); tobacco; nuts; coffee; tea; vines; hops; durian; bananas; natural rubber plants; and ornamentals (such as flowers, shrubs, broad-leaved trees, or evergreens, for example conifers).

The suspension compositions disclosed in the present document, whether neat or as tank mixes, are applied to the field in different amounts depending on the specific active ingredients used, the target crop and the unwanted plant, pest or disease to be controlled. In some embodiments, the active ingredients are each applied in an amount from about 1 g/ha to about 1500 g/ha, or from 300 g/ha to about 1300 g/ha.

The suspension compositions disclosed in the present document can be applied before planting, at the time of planting or after planting.

The invention is further illustrated by the following non-limiting examples.

### EXAMPLES

### Methods:

Preparation of the formulations: the formulation in the examples below (Formulation a-g) were prepared by the following general procedure: for each formulation, all the co-formulants (except for the Kelzan) were added to the water and stirred until fully dispersed. The propanil was then added and the solution homogenized using Ultra turrax (High shear homogenizer) at around 12-14 k rpm for 3 minutes. The suspension was then milled using a WAB lab research instrument with 0.3 mm ZrO₂ ceramic beads until the desired particle size was achieved. After this the Kelzan was added and stirred until full dispersion. The pH was changed by the addition of an NaOH solution.

Freeze thaw experiments: each freeze thaw cycle was performed by taking a 40 ml vial of formulation and placing it in a freezer (−18° C.) until the suspension was frozen, typically several days. The suspension was then allowed to thaw at RT for 1 day.

Viscosity was measured by a Brookfield LV viscometer instrument at 12 rpm at a temperature of 25.0° C. using spindle 62 (for viscosities above 2000 cP, spindle 63 was used).

Particle size was measured using a Malvern Mastersize 2000 instrument equipped with a small sample dispersion unit. Measurement parameters were chosen so that the residual and weighted residual values of the measurements were between 0.8-1.3, for example the refractive index of the sample was set at 1.632 and its absorption at 0.01 for both red and blue light measurements. The background sample time was 20 seconds and the number of background measurement images was 20,000. The sample time was 10 seconds and the number of sample measurement images was 10,000. Both the background and the sample measurements were taken with debubbled water. Drops of the formulation were added to water at RT (20-27° C. at atmospheric pressure) in the unit at a stirring speed of 800 rpm, until the obscuration was between 15-25% and stable (+/−5% of the obscuration value) for a period of at least 2 minutes. Then the measurement was taken.

### Materials:

Atlox 4913: ethoxylated (methyl methacryclate/methacrylic acid) graft polymer
Soprophor TS54: tristyrylphenol ethoxylate (54 ethoxylates)
Morwet D-425: sodium salt of naphthalene sulfonate formaldehyde condensate
Silicaid AF-100: dimethyl polysiloxane emulsion in water
Atlas G5000: nonionic block copolymer polypropylene oxide (PPO)/polyethylene oxide (PEO) butyl ether
Agnique PG 9116: C9-11 polyalkylglycoside
Hi-Sil™ 233: fumed silica
Pluronic PE 10400: nonionic triblock copolymer, PEO/PPO/PEO (MW 3000 PPO), 40% PEO
PVP K-30: poly(vinylpyrrolidone)
XIAMETER ACP-1500: polydimethylsiloxane emulsion
Proxel GXL: 1,2-benzoisothiazolin-3-one+NaOH
Kelzan, Kelzan AP-AS: xanthan gums

### Example 1—Different Antifreeze Systems

Propanil suspension concentrate (SC) formulations a-e, comprising different antifreeze systems, are prepared; the formulations are presented in Table 1 below. All formulations have a pH value of 9 and an initial particle size (D90) of 7 μm.

In a first set of samples of the formulations, particle size is measured after 3 freeze thaw cycles, and their viscosity is qualitatively checked by visual inspection. In a second set of samples of the formulations, particle size and viscosity are checked after 4 days in 40° C. The results are summarized in the following Table 2.

It may be seen that while formulations comprising either urea or propylene glycol as the only antifreeze agent become viscous and show a significant increase in particle size after 3 freeze-thaw cycles, a formulation comprising a combination of propylene glycol and urea in a weight ratio of above 1:1 propylene glycol:urea (formulation b) shows no severe increase in viscosity and a minimal particle growth after 3 freeze-thaw cycles.

TABLE 1

| Ingredient (g/L) | Formulation a | Formulation b | Formulation c | Formulation d | Formulation e |
|---|---|---|---|---|---|
| Propanil | 488.1 | 488.1 | 488.1 | 488.1 | 488.1 |
| Atlox 4913 | 35.5 | 35.5 | 36.0 | 36.0 | 36.0 |
| Soprophor TS54 | 11.8 | 11.8 | 12.0 | 12.0 | 12.0 |
| Morwet D-425 | 4.9 | 4.9 | 5.0 | 5.0 | 5.0 |
| Water solution of | 79.0 | 79.0 | 79.0 | 79.0 | 79.0 |
| Kelzan 2.5% w/w | | | | | |
| and proxel GXL | | | | | |
| 1.7% w/w) | | | | | |
| NaOH 15% | 2.0 | 2.0 | 2.0 | 2.0 | 2.0 |
| Silicaid AF-100 | 3.0 | 3.0 | 3.0 | 3.0 | 3.0 |
| Water | 463.1 | 398.9 | 449.9 | 449.9 | 449.9 |
| Urea | 49.3 | 49.3 | 60.0 | — | 30.0 |
| Propylene glycol | — | 60.0 | — | 60.0 | 30.0 |

TABLE 2

| | Formulation a | Formulation b | Formulation c | Formulation d | Formulation e |
|---|---|---|---|---|---|
| pH | 9 | 9 | 9 | 9 | 9 |
| Initial Particle size | 7 | 7 | 7 | 7 | 7 |
| (D90), μm | | | | | |
| Particle size (D90) | 14.4 | 13.9 | 15.3 | 24.6 | 23 |
| after 4 days at 40 C., | | | | | |
| μm | | | | | |
| Particle size (D90) | 64 | 11.6 | 100 | 187 | 163 |
| after 3 freeze thaw | | | | | |
| cycles, μm | | | | | |
| Qualitative viscosity | Liquid | Liquid | Liquid | Viscous Liquid | Viscous Liquid |
| after 4 days at 40 C. | | | | | |
| Qualitative viscosity | Viscous Liquid | Liquid | Viscous Liquid | Viscous Liquid | Viscous Liquid |
| after 3 freeze thaw | | | | | |
| cycles | | | | | |

### Example 2—Different Propylene Glycol/Urea Ratios

Propanil suspension concentrate (SC) formulations f-g, comprising, as antifreeze systems, urea and propylene glycol in different ratios, are prepared; the formulations are presented in Table 3 below.

The formulations' viscosity and particle size are measured after 3 freeze thaw cycles and after 8 days in 40° C. The results are summarized in the Table 4 below.

TABLE 3

| Ingredient (g/L) | Formulation f | Formulation g | Formulation l | Formulation m | Formulation n |
|---|---|---|---|---|---|
| Propanil | 488.1 | 488.1 | 489.7 | 489.7 | 489.7 |
| Atlox 4913 | 35.5 | 35.5 | 35.8 | 35.8 | 35.8 |
| Soprophor TS54 | 11.8 | 11.8 | 11.8 | 11.8 | 11.8 |
| Morwet D-425 | 4.9 | 4.9 | 4.7 | 4.7 | 4.7 |
| Atlas G5000 | 11.4 | 11.4 | 11.5 | 11.5 | 11.5 |
| Water solution of | 79.0 | 79.0 | 80.24 | 80.24 | 80.24 |
| Kelzan AP-AS 2.5 | | | | | |
| w/w % and 1.7 | | | | | |
| w/w % Proxel GXL) | | | | | |
| NaOH 15% | 2.0 | 2.0 | 2.4 | 2.4 | 2.4 |
| Silicaid AF-100 | 3.0 | 3.0 | 1.8 | 1.8 | 1.8 |
| Water | 389.9 | 359.9 | 420.3 | 418.1 | 388.4 |
| Urea | 49.3 | 49.3 | 38.1 | 36.3 | 34.7 |
| Propylene glycol | 60.2 | 90.2 | 68.7 | 72.7 | 104 |

TABLE 4

| | | Initial | | 8 week storage at 40° C. | | | Freeze/thaw cycles | |
|---|---|---|---|---|---|---|---|---|
| | | particle | | | | Particle | | Particle |
| | Initial | size | | | Viscosity | size d(90) | Viscosity | size d(90) |
| | viscosity | d(90) | Initial | pH after | (cP) after | (μm) after | (cP) after | (μm) after |
| | (cP) | (μm) | pH | storage | storage | storage | 3 cycles | 3 cycles |
| Formulation f | 1370 | 3.1 | 9.05 | 8.99 | 1650 | 14.7 | 1130 | 4.9 |
| Formulation g | 1375 | 3.1 | 9.05 | 9.07 | 1800 | 9.7 | 1150 | 3.1 |
| Formulation l | 1720 | 6.8 | | | 1140 | 16.1 | 2570 | 13.6 |
| Formulation m | 1760 | 6.8 | | | 1150 | 14.6 | 2470 | 11.8 |
| Formulation n | 1560 | 6.8 | | | 1110 | 13.9 | 2780 | 16.6 |

### Example 3—Different pH

Propanil SC formulations h-i are prepared. Their final pH is then adjusted by the addition of small amounts of NaOH 45 w/w % solution. Both formulations have an initial particle size of 7 μm and viscosity of 1500 cP. The particle size and viscosity are measured again after 4 days at 40° C.; the results are presented in Table 5.

TABLE 5

| Ingredient (g/L) | Formulation h | Formulation i |
|---|---|---|
| Propanil | 485.8 | 485.8 |
| Atlox 4913 | 35.5 | 35.5 |
| Soprophor TS54 | 11.8 | 11.8 |
| Morwet D-425 | 4.9 | 4.9 |
| Urea | 49.3 | 49.3 |
| Water solution of | 79.0 | 79.0 |
| Kelzan 2.5 w/w % | | |
| and proxel GXL 1.7 | | |
| w/w % | | |
| SILICAID AF-100 | 3.0 | 3.0 |
| Water | 465.6 | 465.6 |
| Final pH | 5.4 | 8.5 |
| Initial PS (D90), μm | 7 | 7 |
| Particle size (D90) | 20 | 12 |
| (μm) after 4 days at | | |
| 40° C. | | |
| Initial Viscosity (cP) | 1500 | 1500 |
| Viscosity (cP) after | >2500 | 1500 |
| 4 days at 40° C. | | |

### Example 4—Different Dispersant Systems

Propanil SC formulations j-k are prepared (see Table 6). Their viscosity and particle size are measured at room temperature and after 8 weeks at 40° C. The results are presented in Table 7.

After 8 weeks at 40° C., the viscosity of formulation j, which comprises a dispersant combination of Atlox 4913, Morwet D-425 and Soprophor TS54, remains unchanged, while the viscosity of formulation k increases significantly.

TABLE 6

| | |
|---|---|
| Ingredient | Quantity (g/L) |

Formulation j

| | |
|---|---|
| Propanil | 479.8 |
| Atlas G-5000 | 11.4 |
| Atlox 4913 | 35.5 |
| Kelzan AP-AS | 2 |
| Morwet D-425 | 4.9 |
| Propylene glycol | 70 |
| Proxel GXL | 1.3 |
| Silicaid AF-100 | 3 |
| Sodium hydroxide | 2 |
| 45% | |
| Soprophor TS54 | 11.8 |
| Urea prills | 49.3 |
| water | Up to 1 L |

Formulation k

| | |
|---|---|
| Propanil | 479.7 |
| Agnique PG 9116 | 7.3 |
| Ethylenediaminetetraacetic | 2.7 |
| acid, tetrasodium salt | |
| dihydrate | |
| Hi-Sil ™ 233 | 8.5 |
| Kelzan | 2.2 |
| Phosphoric acid solution | 8.5 |
| 85% | |
| Pluronic PE 10400 | 20.6 |
| Propylene glycol | 47.2 |
| Proxel GXL | 1.1 |
| PVP K-30 | 1.2 |
| XIAMETER ACP-1500 | 2.2 |
| zinc oxide zinc oxide | 58.1 |
| powder by Zochem grade | |
| 104 | |
| water | 561.58 |

TABLE 7

| | RT | | | 8 weeks at 40 C. | | |
|---|---|---|---|---|---|---|
| | Particle | | | | Particle | |
| | size | | Viscosity, | Viscosity, | size | |
| Formulation | d(90), μm | pH | cP | cP | d(90), μm | pH |
| k | 6.2 | 8.18 | 1300 | 2302 | 33.3 | 8.11 |
| j | 7 | 8.95 | 1050 | 1050 | 12.1 | 9.21 |

1. An aqueous suspension concentrate composition comprising an anilide herbicide and a dispersant combination comprising: a) a graft or comb copolymer comprising polyalkylene oxide moieties grafted on a polymeric backbone; and b) a polyoxyethylene-polyoxypropylene block copolymer or an alkyl ether thereof.

2. An aqueous suspension concentrate composition comprising an anilide herbicide and a dispersant combination, wherein the dispersant combination comprises: a) a graft or comb copolymer containing polyalkylene oxide moieties grafted on a polymeric backbone; b) an anionic dispersant having an SO3 group; and c) a polyalkoxylate of mono-, di- or tristyrylphenol.

3. The composition of claim 1 or 2, wherein the graft or comb polymer comprises, in polymerized form, methacrylic acid, methyl methacrylate and an ester of polyethylene oxide or a C1-C4 alkylether thereof with methacrylic acid.

4. The composition of claim 2, wherein the anionic dispersant having an SO3 group is a naphthaleneformaldehyde condensate sulfonate or salt thereof.

5. The composition of claim 2, wherein the polyalkoxylate of mono-, di- or tristyrylphenol is a tristyrylphenol ethoxylate.

6. The composition of any of claims 2-5, which further comprises a polyoxyethylene-polyoxypropylene block copolymer or an alkyl ether thereof.

7. The composition of any of claims 1-6, wherein the polyoxyethylene-polyoxypropylene block copolymer or an alkyl ether thereof is a polyoxyethylene-polyoxypropylene block copolymer butyl ether.

8. An aqueous suspension concentrate composition comprising an anilide herbicide, urea and propane-1,2-diol.

9. The composition of any of claims 1-7, which further comprises urea and propane-1,2-diol.

10. The composition of any of claims 8-9, wherein the composition comprises a propane-1,2-diol:urea weight ratio of above 1:1 to about 50:1.

11. The composition according to any of the preceding claims, wherein the pH of the composition is between 7 and 14.

12. The composition according to any of the preceding claims, wherein the anilide herbicide is propanil.

13. The composition according to any of the preceding claims, wherein after 8 weeks in 40° C.: a) the D(90) particle size (when measured on a Malvern Mastersizer 2000) is less than 27 μm or b) the viscosity (when measured using a Brookfield LV viscometer at 12 rpm at a temperature of 25.0° C. using spindle 62) is less than 2500 cP.

14. The composition according to any of claims 2-13 comprising: an anilide herbicide; a dispersant combination comprising a) a graft or comb copolymer containing polyalkylene oxide moieties grafted on a polymeric backbone; b) an anionic dispersant having an SO3 group; and c) a polyalkoxylate of mono-, di- or tristyrylphenol; and a combination of urea and propane-1,2-diol.

15. A process for preparing the composition according to any of the preceding claims, comprising: a) adding the co-formulants except for the active ingredient and the suspending agents and/or thickeners (if present) to the water and stirring until fully dispersed; b) adding the active ingredient and homogenizing; c) milling to the desired particle size; d) optionally, adding the suspending agents and/or thickeners; and e) optionally, modifying the pH by the addition of a base or acid.

16. A method for the control of undesired plants comprising contacting an effective amount of the composition according to any of claims 1-14 with the locus of said undesired plants.

17. A propanil suspension concentrate composition wherein after 8 weeks in 40° C.: a) the D(90) particle size (when measured on a Malvern Mastersizer 2000) is less than 27 μm or b) the viscosity (when measured using a Brookfield LV viscometer at 12 rpm at a temperature of 25.0° C. using spindle 62) is less than 2500 cP.
